(19) United States
(12) Patent Application Publication
(10) Pub. No.: US 2010/0060389 A1
(43) Pub. Date: Mar. 11, 2010

(54) Acoustic Waveguide Array With Nonsolid Cores

(76) Inventors: John K. Schneider, Snyder, NY (US); Jack C. Kitchens, Tonawanda, NY (US)

Correspondence Address: HODGSON RUSS LLP;THE GUARANTY BUILDING, 140 PEARL STREET, SUITE 100, BUFFALO, NY, 14202-4040, US

(21) Appl. No.: 12/554,694

(22) Filed: Sep. 4, 2009

Related U.S. Application Data
(63) Continuation-in-part of application No. 12/055,174, filed on Mar. 25, 2008.
Application No. 12/055,174 is a continuation-in-part of application No. 11/761,101, filed on Jun. 11, 2007.
(60) Provisional application No. 60/804,412, filed on Jun. 9, 2006.

(51) Int. Cl. H01P 3/00; B32B 37/00; B32B 38/10

(52) U.S. Cl. 333/239; 156/60; 156/250; 333/242

(57) ABSTRACT

An acoustic (sound or ultrasound) wave transmitter having a plurality of waveguides is described, and a method of making such a transmitter is described. Each waveguide can have a cladded core. The core can be a liquid such as water, alcohol or mineral oil. Alternatively, the core can be a colloidal gel, such as gelatin dissolved in at least one of water, vinyl plastisol or silicone gel. The cladded core is capable of transmitting acoustic wave energy from a first end surface to a second end surface of the cladded core. The waveguides can be substantially fixed relative to each other by a binder. The binder can be formed by fusing the claddings together, potting a material between the waveguides and/or mechanically holding the waveguides.

### CROSS-REFERENCE TO RELATED APPLICATIONS

This application is a continuation-in-part of U.S. patent application Ser. No. 12/055,174, which was filed on Mar. 25, 2008, and this application claims the benefit of priority to U.S. patent application Ser. No. 12/055,174. Ser. No. 12/055,174 is a continuation-in-part of U.S. patent application Ser. No. 11/761,101, which was filed on Jun. 11, 2007. Ser. No. 11/761,101 claims the benefit of priority to U.S. provisional patent application Ser. No. 60/804,412, which was filed on Jun. 9, 2006. This continuation-in-part patent application also claims the benefit of U.S. patent application Ser. Nos. 11/761,101 and 60/804,412.

### FIELD OF THE INVENTION

This disclosure relates to devices for transmitting information using longitudinal waves, such as sound and ultrasound. The term “acoustic” is used to refer collectively to sound waves and ultrasound waves.

### BACKGROUND

It is well known to use acoustic waves, such as ultrasonic energy, to determine information about an object. For example, in non-destructive testing, ultrasonic energy pulses are used to determine whether flaws exist in an object without damaging the object. Ultrasonic energy pulses are also used to obtain information about the friction ridge surfaces, such as fingerprints, of human beings.

### BRIEF SUMMARY OF THE INVENTION

In one implementation, an acoustic wave transmitter has a plurality of waveguides. Although this document focuses on ultrasound, this is done to illustrate how some implementations of the invention might be implemented. Implementations need not be limited to ultrasound, and it should be recognized that other acoustic waves can be used.

Each waveguide can have a core and cladding. The core can have a first end surface, a second end surface, and a longitudinal surface extending between the first and second end surfaces. The longitudinal surface of the core can be substantially surrounded by the cladding to form a cladded core. The cladded core is capable of transmitting acoustic energy from the first end surface to the second end surface.

The waveguides can be substantially fixed relative to each other by a binder. The binder can be formed by fusing the claddings together, potting a material between the waveguides and/or mechanically holding the waveguides.

The core can be a material having a first shear-wave propagation velocity (“SWPV”). The cladding can be a material having a second shear-wave propagation velocity, and the first SWPV is different from the second SWPV. The second SWPV can be greater than the first SWPV.

The waveguide core can be a liquid such as water, alcohol or mineral oil. Since liquids have a shear wave propagation velocity that is or approaches zero, liquids do not propagate shear stresses to the same extent as solids. A resulting advantage of a waveguide having a liquid core can be that there is no low-frequency cut-off or a very low low-frequency cut-off, thereby alleviating a limitation of prior art waveguides.

Alternatively, the waveguide core can be a colloidal gel, such as vinyl plastisol, gelatin dissolved in water, or silicone gel. Although a colloidal gel can have a shear wave propagation velocity that is greater than liquids, its shear wave propagation velocity is less than solids that can be used for the core of a waveguide. An advantage to using a colloidal gel core is that the colloidal gel can be easier to handle than a liquid when fabricating a waveguide since a colloidal gel will not easily leave a tubular cladding. Another advantage of using a colloidal gel for the core is that colloidal gels can have less attenuation of an acoustic signal than a core which is a solid material, but a colloidal gel core will have more attenuation than the base liquid that comprises such a gel.

The invention can be embodied as a method of making an acoustic wave transmitter. In one such method, a plurality of cladding tubes are provided. The cladding tubes can be fixed relative to each other, and then the cladding tubes can be filled with a liquid. Ends of the cladding tubes can be sealed so as to prevent the liquid core from leaking out of the cladding tube. In this manner, an array of waveguides can be formed, wherein each waveguide has: (1) a cladding having (a) a first end surface, (b) a second end surface, and (c) a longitudinal surface extending between the first and second end surfaces, and (2) a liquid core that is substantially surrounded by the cladding. The core can have a first shear-wave propagation velocity (“SWPV”), and the cladding can have a second SWPV. The second SWPV is greater than the first SWPV.

Each of the plurality of cladding tubes can be substantially fixed to at least one other cladding tube. A binding operation can be carried out by heating the cladding tubes in order to fuse each cladding tube to at least one other cladding tube. Also, the binding operation can be carried out by potting the cladding tubes with a suitable potting material placed between the cladding tubes. Also, the binding operation can be carried out by placing a band around the plurality of cladding tubes.

The waveguides can be formed to a desired length. For example, the cladding tubes can be cut prior to or after the binding operation, and/or the array can be cut or ground to a desired thickness after ends of the cladding tubes are sealed. In one implementation of the method, the cutting operation is carried out so that the first end surfaces of the cladding tubes lie substantially in a plane. Further, the cutting operation can be carried out so that the second end surfaces of the cladding tubes lie substantially in a different plane.

### BRIEF DESCRIPTION OF THE SEVERAL VIEWS OF THE DRAWINGS

For a fuller understanding and disclosure, reference is made to the accompanying drawings and the subsequent description. The invention will now be described by way of non-limiting examples, with reference to the attached drawings and diagrams in which:

FIG. 1A is an isometric view of an ultrasonic wave transmitter according to the invention;

FIG. 1B is a side view of the transmitter depicted in FIG. 1A;

FIG. 1C is a plan view of the transmitter depicted in FIG. 1A;

FIG. 1D is an enlarged view of a portion of the transmitter depicted in FIG. 1C;

FIG. 1E is an enlarged view of a waveguide depicted in FIG. 1D;

FIG. 2A is an end view of a waveguide;

FIG. 2B is a cross-sectional side view of a waveguide taken along the line 2B-2B in FIG. 2A;

FIG. 3 depicts a method according to the invention;

FIG. 4A depicts an assembly of cladding tubes that have not been fixed relative to each other;

FIG. 4B depicts an assembly of cladding tubes for which the claddings are beginning to fuse;

FIG. 4C depicts an assembly of cladding tubes for which the claddings have fused so as to fix the position of the cladding tubes relative to each other;

FIG. 5A depicts an assembly of cladding tubes that have not been fixed relative to each other;

FIG. 5B depicts an assembly of cladding tubes that have been potted so as to fix the position of the cladding tubes relative to each other; and

FIG. 6 is a diagram of an implementation of a fingerprint scanner using a piezoelectric array, a plane wave pulse generator and an acoustic fiber waveguide array to transfer acoustic energy to an ultrasonic detector array. FIG. 5 depicts the scanner in an assembled form and in an exploded form.

### DETAILED DESCRIPTION OF THE INVENTION

To use an ultrasonic energy pulse to obtain information, the pulse must be sent from a device (the “emitter”) that is suitable for emitting ultrasonic energy pulses toward an object to be analyzed, and there must be a device (the “receiver”) that is suitable for receiving the energy once it has been reflected by or passed through the object. For ease of description, we will discuss the situation in which ultrasonic energy is reflected, but it will be recognized that this description (and the invention) can be applicable to situations in which the detected ultrasonic energy passes through the object being analyzed. Furthermore, in order to illustrate the concepts and ideas, the object being analyzed is from time to time described as a fingerprint, but it will be recognized that the invention is not limited to fingerprints.

When the object being analyzed is a fingerprint, a single device can be used to serve as both the emitter and the receiver. Usually, the emitter and the receiver are positioned some distance from the object being analyzed, and so the emitted ultrasonic energy and the reflected ultrasonic energy must travel through a transmittive substance. Air is a transmittive substance for ultrasonic energy, but other substances transmit ultrasonic energy better than air. Another such transmittive substance is mineral oil. Regardless of the choice of transmittive substance, the strength of the ultrasonic energy pulse is weakened and scattered as it passes through the transmittive substance. The result is that by the time the ultrasonic energy arrives at the receiver, the strength of the pulse has greatly diminished.

As a result of scattering caused by the transmittive substance, some of the ultrasonic energy reflected from one part of an object will arrive at a portion of the receiver that is intended for receiving ultrasonic energy from another part of the object. Such scattering tends to reduce the clarity of the information provided by an ultrasonic system.

Traditionally, plastic lenses have been used to collect and focus ultrasonic energy from the image plane of a target object to another image plane where an ultrasonic receiver converts the ultrasonic energy to an electric signal, which then can be used to generate a visual representation of the object. The primary drawbacks in this methodology have been (a) large lens size, and (b) the inability to create short transmission paths for transferring the ultrasonic energy. Additionally, compound lens assemblies frequently must be fabricated to tight mechanical tolerances, which results in increased costs.

The prior ultrasonic systems would be made more effective if there was a way to transmit ultrasonic energy that had less attenuation of the ultrasonic energy pulse and/or that prevented scattering of the ultrasonic energy pulse.

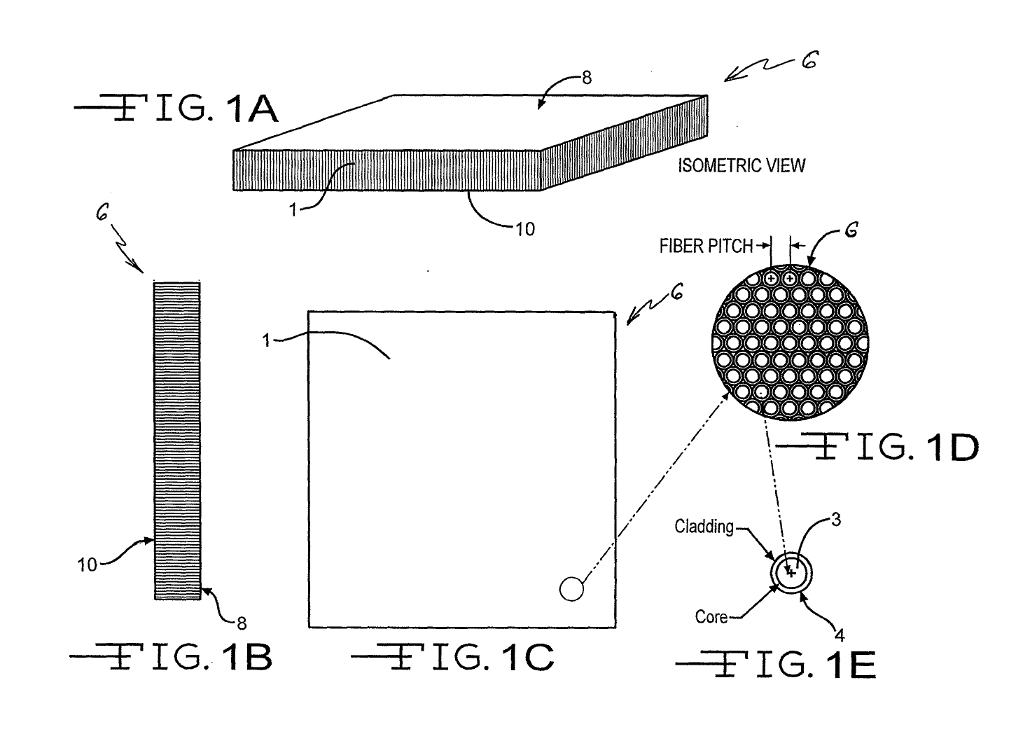

FIGS. 1A through 1E depict an implementation of the invention in which a plurality of substantially parallel ultrasonic waveguides 1 are held together into a single assembly. The assembly is shown in FIGS. 1A, 1B and 1C as an array 6 of waveguides 1. The ultrasonic waveguides 1 can be fibers, and can be thought of as conduits that transmit acoustic wave energy, such as ultrasonic energy, from a first end-surface 8 of the waveguide 1 to a second end-surface 10 of the waveguide 1. Each waveguide 1 in the array 6 can be used to convey a different ultrasonic signal from one side of the array 6 to the other side. In order to preserve the information being transmitted by the waveguides 1, the relative positions of the first end-surfaces 8 of the waveguides 1 can be positioned substantially the same as the relative positions of the second end-surfaces 10 of the waveguides 1.

In an implementation, the array 6 of waveguides 1 is formed so that ultrasonic energy can be conducted from one side of the assembly to the other side. Each waveguide 1 can be constructed to have a core 3 and a cladding 4 substantially surrounding the core 3. The core 3 can be a liquid and the cladding 4 can be substantially solid. For example, the liquid can be water, alcohol or mineral oil. Alternatively, the core 3 can be a colloidal gel, such as such as vinyl plastisol, gelatin dissolved in water, or silicone gel. The propagation velocity of a shear-wave in the core 3 material should differ from the propagation velocity of a shear-wave in the cladding 4 material so that an ultrasonic wave traveling through the waveguide 1 is substantially contained in the waveguide 1 by means of total internal reflection at the interface of the core 3 and cladding 4. Since ultrasonic energy can be used to transmit information, such as fingerprint information, the invention can be used to transmit information about a pattern (such as a fingerprint) from one side of the array 6 to another side of the array 6.

Such an array 6 can be used, for instance, in ultrasonic fingerprint imaging. In this situation, ultrasonic pulses are reflected from a finger. Generally, the finger is placed on a platen, and when the ultrasonic energy arrives at the finger, all or nearly all of the ultrasonic energy is reflected back from areas where the valleys of the fingerprint exist. At the ridges of the fingerprint, most of the energy is absorbed by the finger and only a small quantity of ultrasonic energy is reflected back. At the ridge-valley transition region of the fingerprint, the energy reflected back will be between these two values. The detector then measures the amount of energy received, and then a computer translates that value into a grey scale image that is displayed on a monitor. The array 6 can be placed in the path of the emitted ultrasonic pulse and/or the reflected ultrasonic energy so as to transmit the ultrasonic energy in a manner that minimizes losses and scattering of ultrasonic energy.

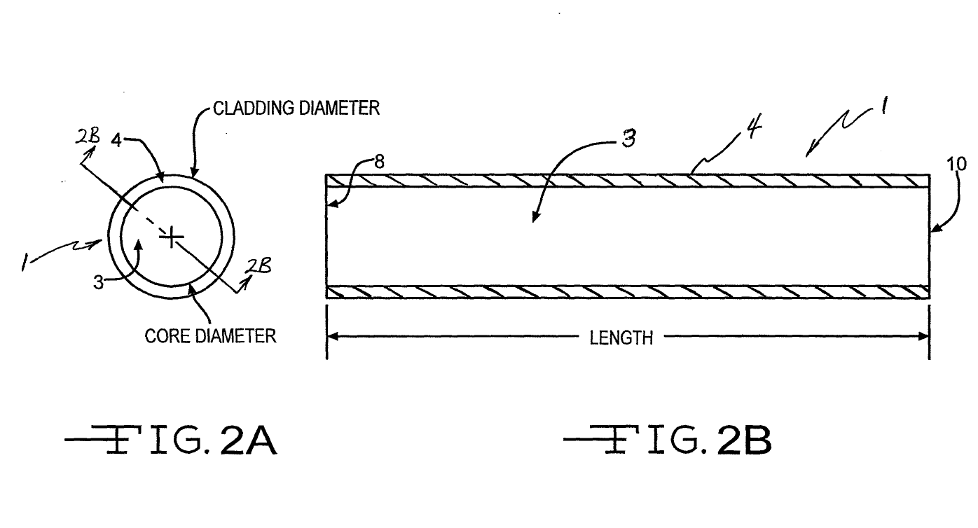

Having described some implementations in general terms, further details are now provided. Each waveguide 1 has a core 3 and cladding 4. FIGS. 2A and 2B depict a waveguide 1. The materials of the core 3 and cladding 4 are selected so that the shear-wave velocity of the cladding 4 is greater than the shear-wave velocity of the core 3. By carefully selecting the core 3 and cladding 4 materials, acoustic energy traveling within the waveguide 1 is substantially confined to the core 3.

Under these conditions, acoustic waves, such as ultrasonic waves, are allowed to propagate along the length of the waveguide 1. The core/cladding interface reflects the shear wave. This condition prevents leakage of the wave energy through the cladding. The greater the differences in shear-wave velocities between the core 3 and cladding 4, the thinner the cladding 4 can be. When ultrasonic energy waves are confined primarily to the material of the core 3, external conditions will have little or no significant effect on transmission of the ultrasonic energy.

Furthermore, in order to propagate through the waveguide 1, the ultrasonic energy should have a wavelength corresponding to a frequency that is at or above a cutoff frequency of the waveguide 1. The cutoff frequency for the waveguide 1 can be determined by:

fc=Vs2d

where “f_{c}” is the cutoff frequency, “Vₛ” is the shear velocity (the velocity perpendicular to the longitudinal velocity vector) of the core 3 and “d” is the diameter of the core 3. Based on the relative differences in shear-wave propagation of the core and cladding materials, the ratio of core 3 diameter to the minimum cladding 4 thickness can be determined. For example, the thickness of the cladding can be determined using Bessel functions, or determined empirically by experimentation.

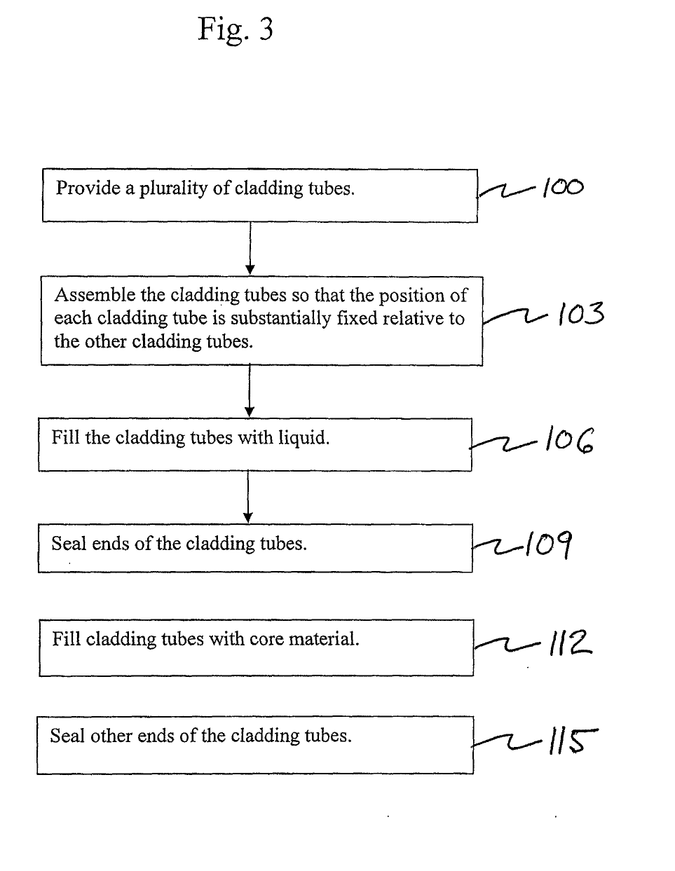

FIG. 3 depicts a method in which the plurality of waveguides 1 are made into an acoustic wave transmitter. Generally speaking, one method of manufacturing such a wave transmitter starts with providing 100 a plurality of hollow cylinders of the cladding 4 material. Each such cladding tube 4 can be prepared with a desired inner diameter. The plurality of cladding tubes 4 can be assembled 103 into an integral unit so that the position of each cladding tube 4 is substantially fixed relative to the other cladding tubes 4. The cladding tubes 4 can then be filled 106 with a liquid, so that the waveguides 1 have a liquid core. The ends of the cladding tubes 4 can be sealed 109 so that the liquid core is prevented from leaving the cladding tubes 4, thereby forming a plurality of waveguides 1 that have been assembled to form an array 6. Since the position of the cladding tubes 4 are fixed relative to the other cladding tubes 4, the positions of the waveguides 1 are fixed relative to the other waveguides 1.

In one implementation of the invention, each waveguide 1 of the array 6 has a core 3 with a diameter of about 40 micrometers and the centers of the waveguides 1 are spaced from each other at about 50 micrometers. The waveguide array 6 can be of any convenient thickness, but the thickness is preferably selected to have back reflected signals arrive at the detector at a time which is much different than the signals used to create the image. Successful waveguide arrays 6 can be fabricated with cores 3 having diameters of 3 micrometers and center-to-center spacing of 4 micrometers. Successful waveguide arrays also can be fabricated with cores having diameters of 250 micrometers and center-to-center spacing of 300 micrometers. However, the waveguide arrays 6 can be fabricated with either larger or smaller cores 3 and spacing than those described herein.

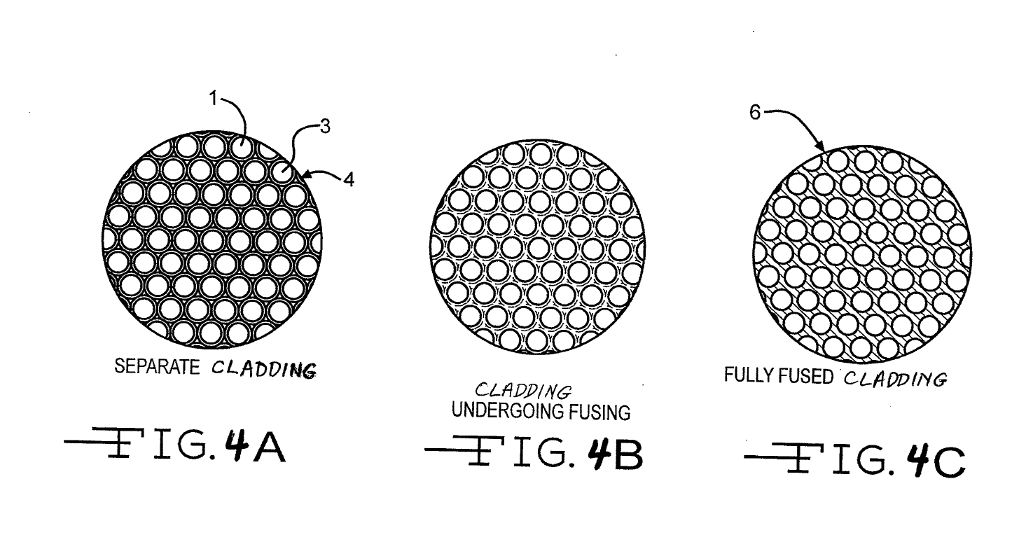

The plurality of cladding tubes 4 can be provided by initially forming a length of the tubular cladding material, and then cutting the cladding material so as to provide a plurality of cladding tubes 4 having similar lengths. The plurality of cladding tubes 4 can be provided 100 and carefully placed close to each other in order to provide a bundle of cladding tubes 4. FIG. 4A depicts a bundle of cladding tubes 4. To form the array 6, the plurality of cladding tubes 4 can be assembled 103 and bound in order to substantially fix each cladding tube 4 to at least one of the other cladding tubes 4 in the bundle. To accomplish this, the bundle can be heated to fuse the cladding tubes 4 to each other, and to exclude interstitial air or gases. FIG. 4B depicts the cladding tubes 4 while the cladding tubes 4 are fusing, and FIG. 4C depicts the cladding tubes 4 once fusing is complete.

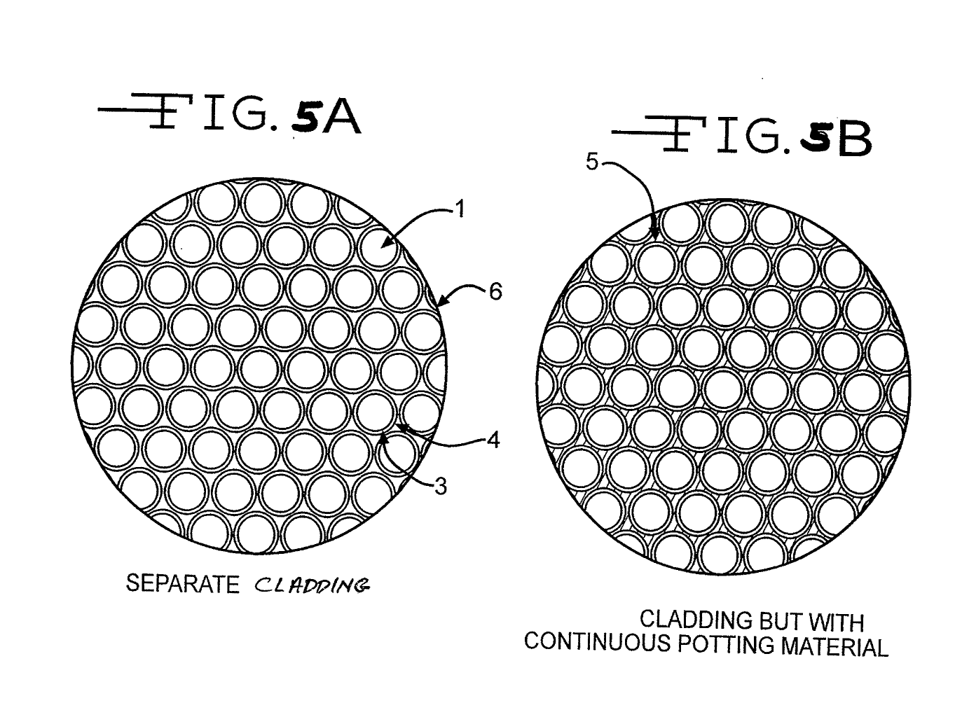

Alternatively, the interstices between the cladding tubes 4 can be filled in order to pot the cladding tubes 4 by using a suitable potting compound 5, such as a two part curing resin system. Epoxy resin systems or a room-temperature vulcanizable silicone rubber are two widely known means that can be used as a potting compound 5. FIG. 5A depicts the cladding tubes 4 prior to potting, and FIG. 5B depicts the cladding tubes 4 after potting.

In lieu of (or in addition to) potting or fusing the cladding tubes 4, the cladding tubes 4 can be mechanically constrained so that the end surfaces 8, 10 of the cladding tubes 4 are not permitted to move relative to each other. For example, a tightly drawn band can be used to mechanically constrain the cladding tubes 4.

Once bundled together, the resulting device can be thought of as an assembly having substantially parallel cladding tubes 4, each having a position that is fixed relative to the other cladding tubes 4 in the assembly. The assembly of cladding tubes 4 can be cut perpendicular to the longitudinal axes of the cladding tubes 4 to provide a array 6 having a desired thickness. In this fashion, the first end-surfaces 8 can lie substantially in a plane. Further, the second end-surfaces 10 can lie substantially in a plane. The end surfaces 8, 10 of the cladding tubes 4 can be polished to a suitable flatness.

Next, a thin material (the “first substrate”) can be bonded to one of the end-surfaces 8, 10 of the cladding tubes 4 so as to seal 109 an end of each cladding tube 4. For example, the first substrate can be a film of plastic, such as polystyrene or polycarbonate, 0.0005 to 0.003 inches thick. The first substrate can be bonded to the cladding tubes 4 by an adhesive, such as cyanoacrylate, silicone RTV, or an epoxy. The adhesive can be applied to the cladding tubes 4 by silk screening, brushing or mask spraying the adhesive to the cladding tubes 4.

With one of the end-surfaces 8, 10 sealed by the substrate, the array 6 of cladding tubes 4 can be filled 112 with the core material by submerging the cladding tubes 4 in the liquid or colloidal gel that will become the core 3 for each waveguide 1. To do so, the core material can be provided in a container, and the container with the submerged cladding tubes 4 can be placed in a vacuum chamber to remove gasses in the cladding tubes 4, and replace that gas with the core material in the container. The array 6 of cladding tubes 4 can be removed from the vacuum chamber. Then a small amount of the core material can be placed on the array 6 to assure the cladding tubes 4 are full of the core material prior to sealing 115 another end of the cladding tubes 4 prior to placing a second substrate on the array 6 of cladding tubes 4. Placing the second substrate should be done so as not to trap gas in the cladding tubes 4, and this can be accomplished by performing the procedure in a bath of the core material or simply adding a sufficient quantity of excess core material in order to form a meniscus that can be displaced when the second substrate is applied. The second substrate can be bonded to the cladding tubes 4 in the same manner as the first substrate.

One set of materials that can offer the qualities needed to create an ultrasonic waveguide 1 and ultimately the array 6 can be water, alcohol or mineral oil for the core 3, and polystyrene (“PS”) for the cladding 4. Another polymer that can be used for the cladding 4 is polycarbonate. Further, glass can be used for the cladding 4. These are only examples of the types of materials that can be used. Other materials can be successfully used to create a suitable ultrasonic waveguide 1.

The array 6 offers an inexpensive means of transmitting acoustic wave energy from one place to another, and does so with a minimum of signal loss. The array 6 can be used to transmit ultrasonic energy from an ultrasonic wave emitter, to a finger, and/or from a finger, to an ultrasonic wave receiver, as part of a system for producing a fingerprint image corresponding to the finger. In one such system, an ultrasonic wave guide array 6 is provided and a finger is placed proximate to a first end surface of the waveguides 1. Ultrasonic energy can be provided by an emitter, and the energy can travel to the finger at least in part via the array 6. Some of the energy provided to the finger can be reflected back toward the array 6. The reflected ultrasonic energy from the finger can be received at first end-surfaces 8 of the waveguides 1 and transmitted via the waveguides 1 to the second end-surfaces 10 of the waveguides 1. The ultrasonic energy leaving the second end-surfaces 10 of the waveguides 1 can be provided to a receiver. The receiver can detect the reflected ultrasonic energy received at various locations on the receiver, and convert the ultrasonic energy to one or more electric signals that are indicative of the strength of the received ultrasonic energy signal. The electric signals can be provided to a computer, which has software suitable for interpreting the electric signal and to generate an image of the fingerprint on a monitor.

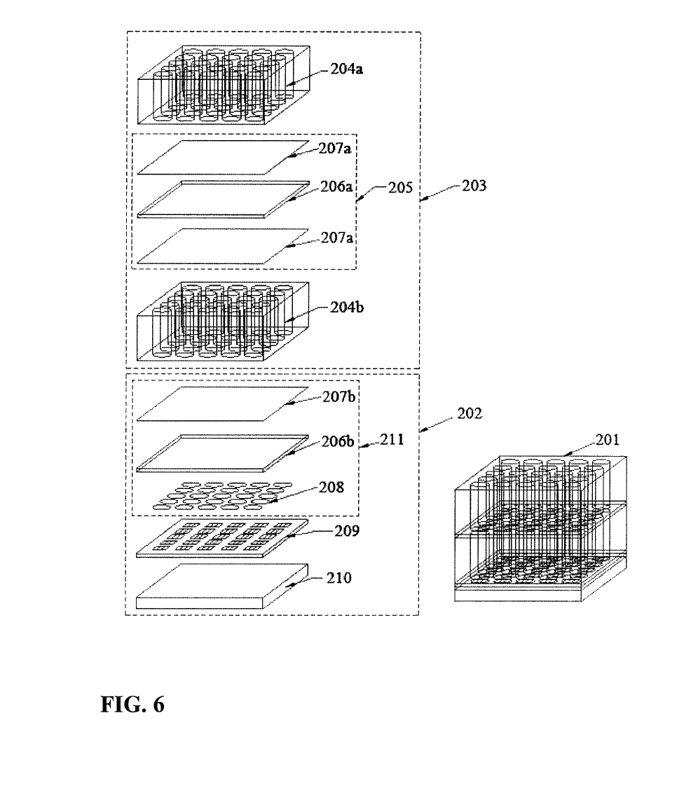

Shown in FIG. 6 is a diagram of an implementation of a fingerprint scanner 201 that is in keeping with the invention. It combines an acoustic detector array 202 and an acoustic pulse array 203 as the two main subassemblies of its construction. The acoustic pulse array 203 doubles as a fingerprint platen where a subject's finger can be placed for imaging. The acoustic detector array 202 can be constructed with standard thin film transistor (TFT) techniques by applying a TFT array 209 onto a substrate 210, then applying an electrode array 208 that is in electrical contact to the inputs of the TFT array 209. Over the electrode array 208, a piezoelectric film 206b can be applied and over-coated with a continuous electrode 207b. The assembly constitutes the acoustic detector array 202 and is sensitive to and will produce signals in response to sonic pressure waves.

The acoustic pulse array 203 can be constructed by sandwiching a plane wave generator 205 between two coherent acoustic waveguide arrays 204. The plane wave generator 205 can include a piezoelectric film 206a which has had electrodes 207a applied to its opposite surfaces. The coherent acoustic waveguide arrays 204a, 204b can be constructed by filling a capillary array with a solid material whose acoustic shear velocity is less than that of the material of the capillary array construction. Typical materials of construction for this technique can be a glass capillary array filled with polystyrene (PS) or polymethylmethacrylate (PMMA) resin. The coherent acoustic waveguide arrays 204a, 204b can also be formed by fusing individual acoustic waveguide fibers 1 so that their claddings form a continuous structure. Typical materials of construction for this method can be a polystyrene (PS) for the individual waveguide fibers in a polymethylmethacrylate (PMMA) matrix. Both methods lend themselves easily to construction techniques used to form fiber optic arrays. If necessary, a thin 0.001″ or 0.002″ thick polymer film can be attached to prevent evaporation of liquid waveguide core material 3.

When the acoustic detector array 202 and the acoustic pulse array 203 are brought together (for example, by adhesively bonding the detector array 202 to the pulse array 203), the details of alignment must be dealt with so as to avoid Moiré patterning effects. This can be achieved by intentional misalignment of waveguides and detector pixels that differ in size or placement. For example, the electrodes of the electrode array 208 can be provided in a highly ordered arrangement. That is to say that the distances between adjacent electrodes are substantially the same, and the center-to-center distances between adjacent electrodes are substantially the same. When the electrodes of the electrode array 208 are provided in such a highly ordered arrangement, the waveguides 1 may be arranged in a manner that is not so ordered, and thus Moiré patterning effects can be avoided. For example, the waveguides 1 can be arranged in the detector array 204b so that the distances between adjacent waveguides 1 vary, and so that the center-to-center distances between adjacent waveguides 1 vary.

Another way of avoiding Moiré patterning effects is to arrange the waveguides 1 in the detector array 204b in a hexagonal-closest packed arrangement, and then positioning the detector array 204b so that the rows of waveguides 1 in the detector array 204b are offset by an angle of about five to ten degrees from the rows of electrodes in the electrode array 208.

Yet another way to avoid Moiré patterning effects is to arrange the waveguides 1 in the detector array 204b in a rectilinear pack arrangement, and then position the detector array 204b so that the rows of waveguides 1 in the detector array 204b are offset by an angle of about five to ten degrees from the rows of electrodes in the electrode array 208.

Regardless of whether a random arrangement, hexagonal-closest packed, or rectilinear pack arrangement is selected, we have found that Moiré patterning effects can be further reduced by selecting waveguides 1 having different diameters. We have found that by selecting waveguides 1 having diameters that vary by up to three percent, or even as high as five percent, is usually enough to avoid Moiré patterning effects.

It will be apparent to those versed in the art that the combination of a plane wave generator 205, an acoustic detector array 202 and an acoustical optics device (here, the waveguide arrays 204a, 204b) that transfers the acoustic image of a biological object to the acoustic detector array 202 constitutes a device suitable for reading the acoustic image of the biological object and that this device can function as a fingerprint reader.

Although the invention has been described in conjunction with a fingerprint scanner or reader, its use can be applied to other applications which seek to create an acoustic image of an object.

Those skilled in the art will recognize that this invention is not limited to the implementations disclosed. They will also recognize that for any configuration presented that the mechanics of imaging a same size image, an enlarged image or a reduced image are similar in practice, and that they only differ in the optics system selected for the particular implementation.

Having given a broad overview of the device depicted in FIG. 6, additional details are now provided. In FIG. 6, there is shown a biometric fingerprint scanner 201 where the platen that receives the finger for imaging is a surface of an acoustic pulse array 203 and the acoustic pulse array 203 is acoustically coupled to an ultrasonic detector array 202. The acoustic pulse array 203 can be constructed of a pair of coherent acoustic waveguide arrays 204 that have a plane wave generator 205 sandwiched between them. The plane wave generator 205 can be constructed of a piezoelectric film 206a and a pair of electrodes 207a that are in intimate contact with the opposite surfaces of the piezoelectric film 206a. The acoustic waveguide arrays 204 can be constructed of materials differing in acoustic properties such that the core material has a lower material shear velocity than that of the matrix within which they are held.

The acoustic detector array 202 can have a semiconductor or TFT array 209 of electronic pixel elements with the ability to be individually addressed by an electronic control means. The semiconductor or TFT array 209 can be affixed to an insulating substrate 210 for support and can have an acoustic hydrophone array 211 intimately affixed to it so that the individual array elements of the semiconductor or TFT array 209 are in electrical contact with the individual pixel element inputs. The hydrophone array 202 can have a continuous electrode 207b on the surface away from the semiconductor or TFT array 209 and an array of electrodes 208 on the surface in contact with the semiconductor or TFT array 209. Between the continuous electrode 207b and the electrode array 208 there can be a piezoelectric film 206b that generates the charge that is measured electronically by the semiconductor or TFT array 209.

Having described implementations of the invention, it is worth noting that when the piezoelectric film 206a is electrically excited, it issues a pressure wave which travels toward and through the waveguide array 204a. Portions of the pressure wave will encounter a ridge of the fingerprint, which is in contact with the array 204a, and if so, most of the pressure wave will continue into the finger where it is scattered or absorbed. On the other hand, if a portion of the pressure wave encounters a valley of the fingerprint, the air residing in the valley will result in the pressure wave being reflected back through the array 204 toward the detector array 202. Once detected at the array 202, an image can be generated by identifying regions where a signal is detected and regions where no signal is detected.

Although the present invention has been described with respect to one or more particular implementations, it will be understood that other implementations of the present invention can be made without departing from the spirit and scope of the present invention.

What is claimed is:

1. An acoustic wave transmitter, comprising:
a plurality of waveguides, each waveguide having a core and cladding, the cladding having (a) a first end surface, (b) a second end surface, and (c) a longitudinal surface extending between the first and second end surfaces, the longitudinal surface substantially surrounding the core to form a cladded core, wherein the core is a liquid material having a first shear-wave propagation velocity (“SWPV”), and the cladding is a material having a second shear-wave propagation velocity, and wherein the second SWPV is greater than the first SWPV;
a binder holding the waveguides so as to substantially fix each waveguide relative to the other waveguides.

2. The wave transmitter of claim 1, wherein the waveguides are substantially the same length.

3. The wave transmitter of claim 1, wherein the first end surfaces of the waveguides lie substantially in a plane.

4. The wave transmitter of claim 1, wherein the second end surfaces of the waveguides lie substantially in a plane.

5. The wave transmitter of claim 1, wherein the binder is a material substantially the same as the material used for the cladding.

6. The wave transmitter of claim 5, wherein the cladding material also serves as the binder, and the binder has been formed by fusing the cladding of a first waveguide to the cladding of a second waveguide.

7. The wave transmitter of claim 1, wherein the binder has been potted to interstices between the waveguides.

8. The wave transmitter of claim 1, wherein the core is water.

9. The wave transmitter of claim 1, wherein the core is alcohol.

10. The wave transmitter of claim 1, wherein the core is mineral oil.

11. A method of making an acoustic wave transmitter, comprising:
providing a plurality of cladding tubes;
binding the cladding tubes so as to substantially fix a position of each cladding tube relative to the other cladding tubes;
filling the cladding tubes with liquid;
sealing ends of the cladding tubes so as to provide a plurality of waveguides, each waveguide having a liquid core;
wherein the liquid cores have a first shear-wave propagation velocity (“SWPV”), and the claddings have a second SWPV, wherein the second SWPV is greater than the first SWPV.

12. The method of claim 11, wherein the cladding tubes are made substantially the same length by cutting the cladding tubes to a desired length.

13. The method of claim 11, wherein binding is carried out by heating the cladding tubes to fuse at least one cladding tube to another cladding tube.

14. The method of claim 11, wherein binding is carried out by placing a potting material between the cladding tubes.

15. The method of claim 11, wherein binding is carried out by placing a band around the plurality of cladding tubes.

16. The method of claim 11, further comprising cutting the bound cladding tubes so that the first end surfaces of the cladding tubes lie substantially in a plane.

17. The method of claim 16, further comprising cutting the bound waveguides so that the second end surfaces of the waveguides lie substantially in a plane.

18. The method of claim 11, wherein the core is water.

19. The method of claim 11, wherein the core is alcohol.

20. The method of claim 11, wherein the core is mineral oil.

21. An acoustic wave transmitter, comprising:
a plurality of waveguides, each waveguide having a core and cladding, the cladding having (a) a first end surface, (b) a second end surface, and (c) a longitudinal surface extending between the first and second end surfaces, the longitudinal surface substantially surrounding the core to form a cladded core, wherein the core is a colloidal gel having a first shear-wave propagation velocity (“SWPV”), and the cladding is a material having a second shear-wave propagation velocity, and wherein the second SWPV is greater than the first SWPV;
a binder holding the waveguides so as to substantially fix each waveguide relative to the other waveguides.

22. The wave transmitter of claim 21, wherein the waveguides are substantially the same length.

23. The wave transmitter of claim 21, wherein the first end surfaces of the waveguides lie substantially in a plane.

24. The wave transmitter of claim 21, wherein the second end surfaces of the waveguides lie substantially in a plane.

25. The wave transmitter of claim 21, wherein the binder is a material substantially the same as the material used for the cladding.

26. The wave transmitter of claim 25, wherein the cladding material also serves as the binder, and the binder has been formed by fusing the cladding of a first waveguide to the cladding of a second waveguide.

27. The wave transmitter of claim 21, wherein the binder has been potted to interstices between the waveguides.

28. The wave transmitter of claim 21, wherein the core is gelatin dissolved in at least one of water, vinyl plastisol or silicone gel.

29. A method of making an acoustic wave transmitter, comprising:
providing a plurality of cladding tubes;
binding the cladding tubes so as to substantially fix a position of each cladding tube relative to the other cladding tubes;
filling the cladding tubes with a colloidal gel;
sealing ends of the cladding tubes so as to provide a plurality of waveguides, each waveguide having a colloidal gel core;
wherein the colloidal gel cores have a first shear-wave propagation velocity (“SWPV”), and the claddings have a second SWPV, wherein the second SWPV is greater than the first SWPV.

30. The method of claim 29, wherein the cladding tubes are made substantially the same length by cutting the cladding tubes to a desired length.

31. The method of claim 29, wherein binding is carried out by heating the cladding tubes to fuse at least one cladding tube to another cladding tube.

32. The method of claim 29, wherein binding is carried out by placing a potting material between the cladding tubes.

33. The method of claim 29, wherein binding is carried out by placing a band around the plurality of cladding tubes.

34. The method of claim 29, further comprising cutting the bound cladding tubes so that the first end surfaces of the cladding tubes lie substantially in a plane.

35. The method of claim 34, further comprising cutting the bound waveguides so that the second end surfaces of the waveguides lie substantially in a plane.

36. The method of claim 29, wherein the core is gelatin dissolved in at least one of water, water and alcohol, vinyl plastisol or silicone gel.
